(19) United States
(12) Patent Application Publication
(10) Pub. No.: US 2025/0131641 A1
(43) Pub. Date: Apr. 24, 2025

(54) Format and mechanism for efficient geometry specification

(71) Applicant: Advanced Micro Devices, Inc., Santa Clara, CA (US)

(72) Inventors: David Kirk McAllister, Holladay, UT (US); Joshua David Barczak, Forest Hill, MD (US); Andrew Erin Kensler, Seattle, WA (US)

(21) Appl. No.: 18/753,602

(22) Filed: Jun. 25, 2024

Related U.S. Application Data
(60) Provisional application No. 63/591,885, filed on Oct. 20, 2023.

(51) Int. Cl. G06T 15/06; G06T 1/20; G06T 1/60

(52) U.S. Cl. CPC G06T 15/06; G06T 1/20; G06T 1/60; G06T 2210/21

(57) ABSTRACT

Systems and methods described herein for encoding geometrical primitives into data blocks are disclosed. In an implementation, these data blocks can be directly consumed by an application programming interface (API) for ray traversal or rasterization. A graphics application running on a ray tracing system provides primitive data to the graphics API using a data format that defines fixed-point, compressed, and fixed-size data blocks to store encoded primitive data. The stored data can be decompressed to construct an acceleration structure. Data from the graphics application undergoes geometry clustering in a manner that these can be directly exposed by the API to be consumed by a processing circuitry when constructing acceleration structures.

### CROSS REFERENCE TO RELATED APPLICATIONS

This application claims priority to Provisional Patent Application Ser. No. 63/591,885, entitled “Format and Mechanism for Efficient Geometry Specification” filed Oct. 20, 2023, the entirety of which is incorporated herein by reference.

### BACKGROUND

### Description of the Related Art

Ray tracing involves simulating how light moves through a scene using a physically-based rendering approach. Although it has been extensively used in cinematic rendering, it was previously deemed too demanding for real-time applications until recently. A critical aspect of ray tracing is the computation of visibility for ray-scene intersections, achieved through a process called “ray traversal.” This involves calculating intersections between rays and scene objects by navigating through and intersecting nodes organized in a bounding volume hierarchy (BVH).

Current BVH building algorithms face several data management challenges. One issue is the efficient handling of large datasets, which can become computationally expensive and memory-intensive. The construction process involves sorting and partitioning objects, which can be time-consuming, particularly for dynamic scenes where objects frequently move or change. Maintaining balance in the hierarchy is also problematic, as unbalanced trees can lead to inefficient traversal and increased computational overhead. Additionally, parallelizing the construction process to leverage multi-core processors introduces complexity in data synchronization and load balancing. Memory access patterns during both construction and traversal can lead to cache inefficiencies, further impacting performance.

Lossy compression of geometric data for BVH construction can further present several challenges. First, maintaining the integrity and precision of the geometric data is critical. Any loss of accuracy can lead to errors in BVH traversal and intersection tests, impacting the overall efficiency and correctness of the algorithm. Compressing the data without losing detail requires sophisticated techniques that can handle the complexity and variability of geometric shapes, which often results in increased computational overhead during both compression and decompression stages.

Another issue is the need for efficient access and manipulation of the compressed data. During BVH construction, frequent access to geometric data is necessary for partitioning and sorting operations. Compression can hinder this process by introducing delays in data retrieval and increasing the complexity of data manipulation. Furthermore, the varying size and structure of geometric data can complicate the design of a universal compression scheme that performs well across different types of geometry.

In real-time applications, the compression and decompression processes are particularly challenging when dealing with large and complex datasets. Additionally, ensuring compatibility with existing hardware and software infrastructure while maintaining the benefits of compression adds another layer of difficulty. Overall, while lossless compression can save storage space and potentially improve memory usage, the challenges associated with maintaining data integrity, ensuring efficient access, and managing computational overhead must be carefully addressed to make it viable for BVH construction.

In view of the above, improved systems and methods for data management for construction of acceleration structures are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates the details of the computing system.

FIG. 3 is an illustration of a bounding volume hierarchy (BVH), according to an implementation.

FIG. 4 is a block diagram illustrating encoding of primitive data for generation of acceleration structures.

FIG. 5 illustrates a ray tracing system for constructing an acceleration structure, using quantized primitive data.

FIG. 6 illustrates a method for encoding primitive data using DGF blocks to be used for constructing acceleration structures.

FIG. 7 illustrates a method for constructing an acceleration structure using encoded primitive data.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for encoding geometrical primitives into data blocks are disclosed. In an implementation, these data blocks can be directly consumed by processing circuitry (e.g., GPU) through an application programming interface (API) for ray traversal or rasterization. In implementations described herein, a graphics application running on a ray tracing system provides primitive data to the graphics API using a data format that defines fixed-point, compressed, and fixed-size data blocks, rather than large arrays of floating point primitives typically used to store triangle mesh data. The data stored using these fixed-size data blocks can be decompressed to construct an acceleration structure. In one implementation, data from the graphics application undergoes geometry clustering and this clustered primitive data is stored using the data blocks such that these can be directly exposed by the API to be consumed by a processing circuitry when constructing acceleration structures. In this manner, faster and more economical BVH builds can be realized.

To store primitive data in the data blocks, primitives are clustered in a manner such that each data block stores data corresponding to primitives that are spatially localized in a given scene. That is, data in each data block corresponds to primitives that can be grouped together to represent a single node of the acceleration structure (e.g., bottom-level acceleration structure or BLAS internal node). Since the primitives are clustered before a processor constructs the resulting acceleration structure, build speed can be substantially enhanced. The BLAS internal node can then be combined with other top-level acceleration structures (TLAS) and BLAS nodes to complete construction of the BVH.

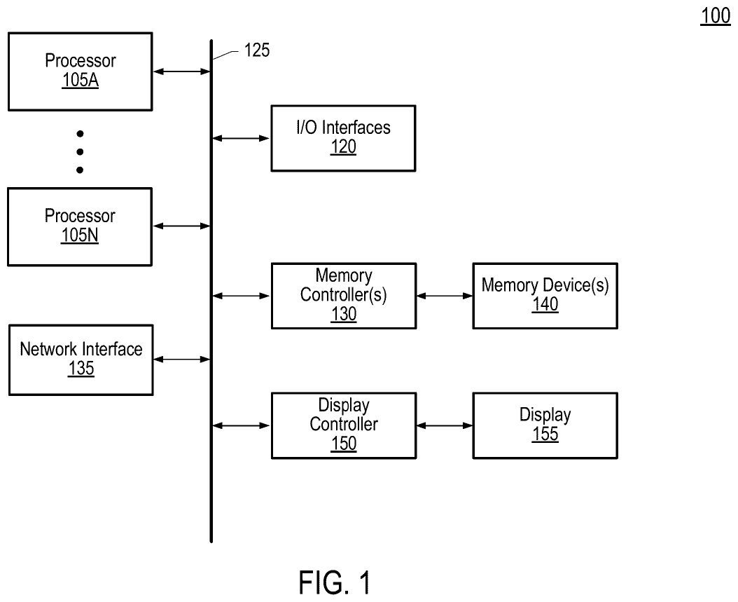

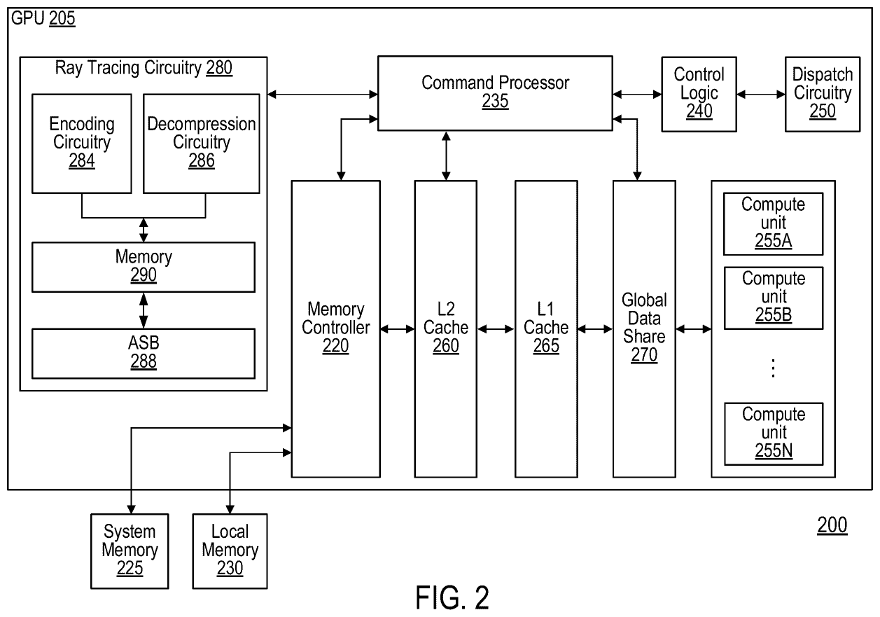

Referring now to FIG. 1, a block diagram of one implementation of a computing system 100 is shown. In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 2-6 herein.

In one implementation, processor 105A is a general purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

Turning now to FIG. 2, a block diagram of another implementation of a computing system 200 is shown. In one implementation, system 200 includes GPU 205, system memory 225, and local memory 230. System 200 also includes other components which are not shown to avoid obscuring the figure. GPU 205 includes at least command processor 235, control circuitry 240 (shown as control logic), dispatch circuitry 250, compute units (or “compute circuits”) 255A-N, memory controller circuitry 220, global data share 270, level one (L1) cache 265, and level two (L2) cache 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1). System 200 further includes ray tracing system 280 including encoding circuitry 284, decompression circuitry 286, acceleration structure builder (ASB) 288, and memory 290.

In an implementation, the encoding circuitry 284 is configured to encode primitive data. In one example, the primitive data includes individual triangle meshes, wherein each triangle mesh includes data pertaining to multiple individual triangles. In one implementation, the data is pre-quantized by the encoding circuitry 284 to generate data nodes, wherein each data node includes an array of fixed-size data blocks storing the primitive data. This quantized node data is stored in a memory (e.g., memory 290) such that it can be accessed by the ASB 288 for building one or more acceleration structures, e.g., bounding volume hierarchy (BVH). In one implementation, at the time of BVH construction, a node within the BVH can be constructed simply by using data stored in the fixed-size data blocks. In one example, each data block can store data for up to 64 triangles, whereas each array can store data pertaining to 256 triangles, 256 vertices, and 64 materials.

In various implementations, computing system 200 executes any of various types of software applications. As part of executing a given software application, a host CPU (not shown) of computing system 200 launches kernels to be performed on GPU 205. Command processor 235 receives kernels from the host CPU and uses dispatch circuitry 250 to issue corresponding wavefronts to compute units 255A-N. Wavefronts executing on compute units 255A-N read and write data to global data share 270, L1 cache 265, and L2 cache 260 within GPU 205. Although not shown in FIG. 2, in one implementation, compute units 255A-N also include one or more caches and/or local memories within each compute unit 255A-N.

In one implementation, ray tracing system 280 is configured to perform ray tracing operations by constructing an acceleration tree structure (e.g., a bounding volume hierarchy or BVH), for testing intersection between light rays and objects in a scene geometry. In an implementation, based on identified geometrical objects in a scene, acceleration structures are formed by ray tracing system 280 and are stored in system memory 225 and/or local memory 230. An acceleration structure is stored in the memory, and the ray tracing system 280 further executes optimizations on the structure. Once a given acceleration structure is optimized, ray intersection tests are performed and the ray tracing system 280 uses the optimized structure to test ray intersections in a given scene geometry. In one implementation, these tests are used by shader programs running on the compute units 255A-N to generate images using ray tracing accelerated by the optimized structure. The images are then queued for display by the command processor 235.

Traditionally, when constructing acceleration structures like a BVH, a graphics API receives primitive data from a graphics application that enables an acceleration structure builder (like ASB 288) to construct a BVH for efficient rendering and collision detection. The graphics application defines the object geometry using primitives such as triangles, lines, or points, wherein each primitive is represented by vertices, which include position, normal, texture coordinates, and other attributes. Further, transformation matrices (e.g., translation, rotation, scaling) are applied to the primitives to position them correctly in the world space. The application then organizes vertex data into vertex buffers, which are contiguous memory blocks that store vertices. Further, index buffers are used to define the order in which vertices are assembled into primitives. Vertex and index buffers are encapsulated in buffer objects that the graphics API can manage and use. The application makes API calls to upload the vertex and index buffer data to a ray tracing system. Shaders programs are executed on the ray tracing system to process vertex and fragment data. The ray tracing system executes a BVH construction algorithm, e.g., often implemented in compute shaders or through dedicated GPUs and/or accelerators. The primitives are organized into a hierarchical structure of bounding volumes. Each node in the acceleration structure represents a bounding volume that contains a subset of the primitives or other bounding volumes. The acceleration structure is stored in a memory (e.g., local memory 230) for efficient traversal during rendering or ray tracing.

In one implementation, triangle mesh models can be used when constructing acceleration structures, such as bounding volume hierarchies (BVHs) or spatial partitioning grids. When using these mesh models, geometric data is gathered that defines a triangle mesh model. This data can include vertex positions, vertex normals (vectors associated with a vertices of a 3D mesh), texture coordinates, and connectivity information (defining triangles by vertex indices). Each triangle in the mesh is then defined by three vertices and may optionally include other attributes like normals and texture coordinates. For each triangle, additional data like a bounding box or bounding sphere can be computed to quickly assess its spatial extent. For example, a bounding volume (typically an AABB—axis-aligned bounding box) for each triangle in the mesh can be computed.

In one or more implementations, large triangle mesh models can substantially increase rendering times in ray tracing due to the complexity of intersecting rays with detailed geometry. Ray-object intersection tests must be performed for each ray and potentially against numerous triangles, thereby leading to higher computational demands. Large triangle mesh models further require significant memory resources to store and process during ray tracing. Memory-intensive data structures are needed to organize and efficiently access the mesh data during ray-object intersection calculations. Ray tracing methods may also require additional memory for storing intermediate results (like ray origins, directions, and shading information) during rendering.

Traditional models used in processing mesh models for building acceleration structures can therefore cause negative impacts on content authoring in ray tracing, since these models do not provide for compact storage of large triangle meshes. Further, since ray tracing often involves processing large amounts of geometric and shading data, including vertices, normals, texture coordinates, and material properties, this data can be voluminous, especially for complex scenes with detailed geometry. Traditional quantization techniques can also fail to preserve the necessary precision of geometric and shading data to avoid visual artifacts or inaccuracies in the rendered image. Further, these methods introduce overhead in terms of decompression time and memory usage. Quantization techniques that disrupt sequential access patterns or require decompressing large blocks of data at once can be inefficient for real-time rendering. Furthermore, lossy compression techniques sacrifice data fidelity to achieve higher compression ratios. While this might be acceptable for certain types of data (e.g., textures), it can be problematic for geometric data where precision is critical.

In implementations described herein, a graphics application running on the ray tracing system 280 provides primitive data to a graphics API (not shown) using a data format that defines fixed-point, compressed, and fixed-size data blocks, rather than large arrays of floating point primitives, typically used to store triangle mesh data. The data stored using these fixed-size data blocks can be efficiently decompressed by the decompression circuitry 286 and used by ASB 288 to construct an acceleration structure. In one implementation, data from the graphics application undergoes geometry clustering and this clustered primitive data is stored using fixed-size data blocks (e.g., blocks of 128 bytes). In an implementation, data in these blocks can be directly exposed by the API to be consumed by a processing circuitry (e.g., ASB 288) when constructing acceleration structures.

In one implementation, in order to store primitive data in the data blocks, primitives are clustered in a manner such that each data block stores data corresponding to primitives that are spatially localized in a given scene. That is, data in each data block corresponds to primitives that can be grouped together to represent a single node of the acceleration structure (e.g., bottom-level acceleration structure or BLAS internal node). Since the primitives are clustered before the ASB 288 constructs the resulting acceleration structure, build speed can be substantially enhanced. For example, a predetermined number of data blocks (e.g., storing data for a total of 65-128 primitives) can together form a data node that represents a single BLAS internal node of a BVH. A data node reference is generated for each data node storing multiple data blocks, e.g., at a point when these data nodes are baked. As described herein, “node baking” refers to the process of precomputing and storing node data or computations for use during runtime. This reference can be mapped to the BLAS node it represents. The ASB 288 then constructs the BLAS node based on the data node reference. This acceleration structure can then be combined with other top-level acceleration structures (TLAS) and BLAS nodes to complete construction of the BVH. These and other implementations are described herein.

In one or more implementations, an API receiving primitive data stored using fixed-point data blocks has the advantages of lossless compression, while remaining true to an application developer's intent for the data. Lossy compression of data can reduce quality and may violate the developer's intent. The implementations described herein allow the developer to provide pre-quantized primitive data of any bit width, and the graphics API can preserve the data's intent precisely. Further, providing quantized primitive data in fixed-sized data blocks can help avoid any rewriting or repacking of the application data.

In an implementation, during operation, a host processor (not shown) prepares and structures triangle data and transfers the triangle data to the encoding circuitry 284. The encoding circuitry 284 encodes the triangle data into the fixed-size data blocks suitable for processing (as described above). Further, a Peripheral Component Interconnect Express (PCIe) bus (not shown) or Direct Memory Access (DMA) facilitates efficient transfer of encoded triangle data between the encoding circuitry 284 and the ASB 288. For instance, the encoded data is moved from the one or more output buffers (not shown) of the encoding circuitry 284 to the input buffers (not shown) of the ASB 288. The ASB 288 constructs and optimizes the BVH. Furthermore, the optimized BVH (or other acceleration structures) are stored in the local memory 230, e.g., Video Random Access Memory (VRAM), for access during ray tracing. The ray tracing circuitry 280 can access the optimized BVH from the local memory 230 and execute ray tracing computations using the BVH. It is noted that the above described data flow operation(s) is merely illustrative and other implementations of data flow between various circuitries is possible. Such implementations are contemplated.

In an implementation, ray tracing system 280 as described herein refers to specialized hardware components or dedicated processing units designed to accelerate ray tracing, a rendering technique used in computer graphics to generate highly realistic images by simulating the behavior of light. Although shown as integral to the GPU 205, in one or implementations, the ray tracing system 280 can also be a standalone hardware unit or circuitry. These implementations are contemplated.

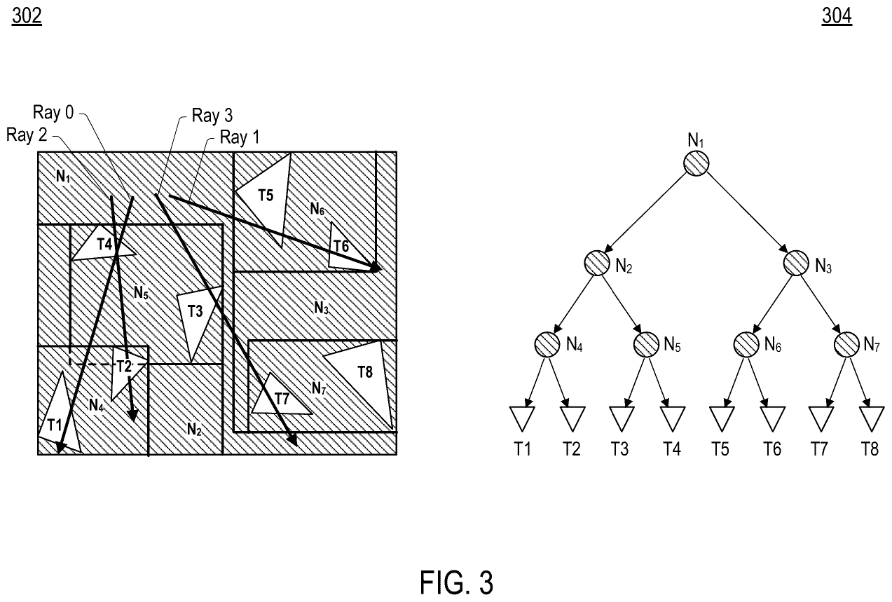

FIG. 3 is an illustration of a bounding volume hierarchy (BVH), according to an implementation. For simplicity, in the exemplary implementation depicted in FIG. 3, the hierarchy is shown in two-dimension. However, in various alternate implementations, extension to three-dimension may be possible, and it should be understood that the methods described herein would generally be applicable to three-dimensional hierarchies as well.

The spatial representation 302 of the BVH is illustrated in the left side of FIG. 3 and the tree representation 304 of the BVH is illustrated in the right side of FIG. 3. In one example, the bounding volumes are represented by “N,” such that N1-N7, are distinct bounding boxes. In the example, bounding box N1 encompasses all other bounding boxes N2-N7. Further, each bounding box N2-N7 includes one or more triangles, that represent geometric objects, and are denoted by “T.” For example, bounding box N1 includes all other bounding boxes and their respective triangles T1-T8. In a similar manner, bounding box N2 includes smaller bounding boxes N5 and N4, such that N4 includes triangles T1 and T2, and N5 includes triangles T4 and T3. Further, for the sake of brevity, in the tree representation 304 the bounding boxes are each represented by a non-leaf node “N” and each triangle is represented by leaf nodes T.

In order to perform ray tracing for a scene, a processing unit (e.g., ray tracing system 280 of FIG. 2) performs a ray intersection test by traversing through the tree 304, and, for each bounding box tested (i.e., by traversing respective internal nodes N), eliminating branches below a traversed node if the test for that node fails. In one example, it is assumed that ray 1 intersects triangle T5 as the closest hit. The processing unit would test against bounding box N1 and then after returning a hit, fetch the resulting child node, which contains bounding boxes for the next level of hierarchy below N1 (nodes N2 and N3). When this node data returns from memory, bounding boxes for N2 and N3 are tested. The processing unit returns a failure or miss result against bounding box N2 (since ray 1 does not interact with the bounding box). The processing unit eliminates all sub-nodes of node N2. Since ray 1 does interact with bounding box N3, it would return a hit and then subsequently fetch N3 from memory, which contains bounding boxes for N6 and N7. Tests are then performed against bounding boxes N6 and N7, by traversing through their respective representative nodes N6 and N7, noting that the test for node N6 succeeds but for node N7 fails. The processing unit would then test triangles T5 and T6 by traversing through representative leaf nodes T5 and T6, noting that test determines that T5 is the closest hit for the ray, and therefore the test for T5 succeeds, but T6 fails (even though the ray might hit T6, however it is not the closest hit).

In an implementation, the BVH 304 is constructed using a given scene geometry. The scene geometry includes individual primitives (e.g., triangles T1-T8) and bounding boxes (represented by nodes N) that describe a scene comprising one or more geometric objects, which are provided by an application or other entity. In various examples, the BVH 304 is constructed using one or more shader programs, such as executing on a processing circuitry (e.g., ASB 288), or on a hardware circuitry in a command processor. In various embodiments, the BVH 304 is constructed prior to runtime. In other examples, the BVH 304 is constructed at runtime, on the same computer that renders the scene using ray tracing techniques. In various examples, a driver, an application, or a hardware unit of a command processor performs this runtime rendering.

In one or implementations, the BVH 304 can be formed as a combination of top level acceleration structure (TLAS) and bottom-level acceleration structure (BLAS). The TLAS nodes (e.g. nodes N2 and N3) is a hierarchical data structure that organizes a collection of BLAS nodes representing individual geometric objects or primitives (e.g., nodes N4-N7 including triangles T1-T8) within a scene. The TLAS is designed for rapid traversal of rays through the scene by identifying relevant BLAS instances that may intersect with the ray. In an implementation, data pertaining to geometric primitives, e.g., to be utilized for building the BVH 304 can quantized in a manner that a ray tracing application can compute quantized geometry representation and upload this data to a GPU memory for further processing.

In an implementation, the BLAS node data includes individual triangle meshes, wherein each triangle mesh includes data pertaining to multiple individual triangles. In one implementation, the BLAS node data is pre-quantized by an encoding circuitry to generate data nodes, wherein each data node includes an array of fixed-size data blocks storing primitive data. This quantized node data is stored in a memory (e.g., memory 290) such that it can be accessed by an acceleration structure builder (e.g., ASB 288) for building one or more acceleration structures, such as BVH 304. In one implementation, at the time of BVH construction, a BLAS internal node can be generated simply by using data node references corresponding to the BLAS internal node. In one example, each data block can store data for up to 64 triangles, whereas each array can store data pertaining to 256 triangles, 256 vertices, and 64 materials. This data can be stored in a GPU memory (e.g., local memory 230) and processed to complete building of the BVH 304.

As described previously, a graphics application running on the ray tracing system issues primitive data to a graphics API (not shown) using a data format that includes fixed-size data blocks, rather than large arrays of floating point primitives. The data stored using these fixed-size data blocks can be decompressed and used to construct the BVH 304. In one implementation, data from the graphics application undergoes geometry clustering and this clustered primitive data is stored using these fixed-size data blocks (e.g., blocks of 128 bytes). In an implementation, these blocks can be directly consumed by a ray tracing system, through a graphics API, when constructing acceleration structures, such as the BVH 304.

In one implementation, primitive data is stored in each data block by first clustering the primitives by the encoding circuitry, e.g., based on spatial localization of each primitive with respect to other primitives in a given scene. That is, data in each data block corresponds to primitives that can be grouped together to represent a single node of the acceleration structure (e.g., BLAS internal node). As the primitives are already clustered before the BVH 304 is constructed, build speed can be substantially enhanced. For example, multiple data blocks (e.g., storing data for a total of 65-128 primitives) can together form a data node that represents a single BLAS internal node of a BVH (e.g. node N4). The BLAS node can be constructed using a reference stored for the data node. The BLAS internal node stores bounding boxes (one or more boxes for each DGF block), and pointers or indices which are used to calculate the address of the DGF blocks in memory. In an implementation, a link between vendor-specific BLAS nodes and the DGF blocks are created as references. These BLAS nodes can then be combined with other TLAS and BLAS nodes to complete construction of the BVH 304.

In an implementation, a data structure comprising one or more data fields, each containing information pertaining to the different nodes of the BVH 304, for which intersection testing is to be performed, is stored in a memory location accessible by the ray tracing system. For example, the data structure is stored in system memory 225 or local memory 230 (as shown in FIG. 2), such that each time a hierarchical tree is created and/or updated, the data structure is updated by the ray tracing system. An exemplary data structure includes node metadata such as, but not limiting to, node references, node surface areas, node subtree information, node lock status, and node bounding boxes, etc.

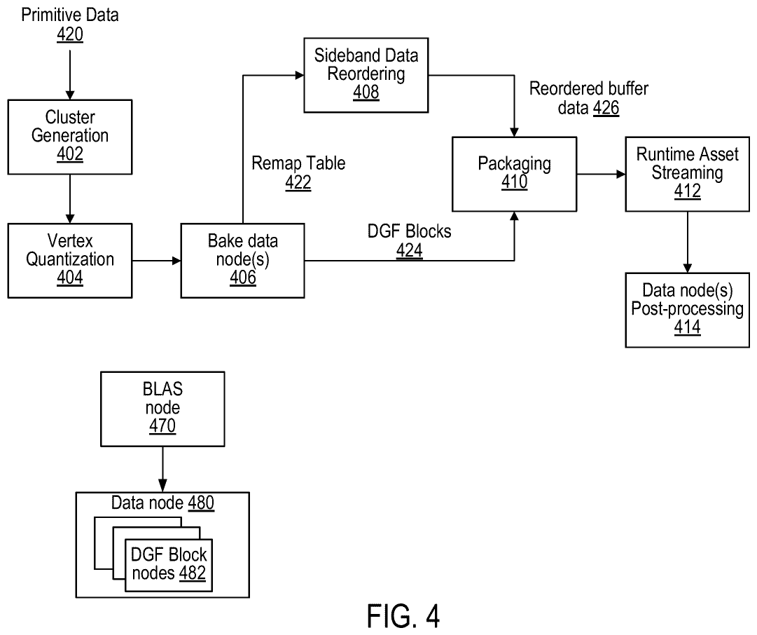

Turning now to FIG. 4, a block diagram illustrating encoding of primitive data for generation of acceleration structures is described. As described in the foregoing, geometrical primitives included in primitive meshes are encoded (e.g., by encoding circuitry 284 of FIG. 2) and the encoded data is stored using data arrays of fixed-size data blocks (e.g., blocks of 128 bytes) to be directly consumed by a processing circuitry (e.g., GPU 205) for ray traversal or rasterization. In one or more implementations, the encoded data is generated in the form of a “dense geometry format (DGF)” data block. As referred to herein, a DGF data block includes various data buffers to store information pertaining to vertex indices, geometry identifiers, mesh connectivity, and opacity data pertaining to each primitive in the mesh. In one implementation, the DGF block is a fixed-size data block, e.g., consisting of an array of data blocks of 128 bytes that encode triangle data. In this example, each data block stores a maximum of 64 triangles and 64 vertices. This data structure enables partitioning triangle meshes into small, spatially localized triangle sets, and “packs” each set into a minimal number of DGF blocks.

In an implementation, primitive data 420 is initially clustered by the encoding circuitry using a surface area heuristic (SAH) clustering strategy (block 402) for building acceleration structures efficiently. Pre-clustering the geometry based on SAH accelerates the BVH build, since a BVH builder (e.g., ASB 288 described in FIG. 2) receives an efficient spatial partitioning, and does not need to construct the partitioning from the original, larger triangle set. Initially, all triangles are clustered in a single cluster representing the root of a BVH (e.g., BVH 304). A splitting plane (axis-aligned) that divides the current cluster of triangles into two sub-clusters is then chosen. In one implementation, the choice of the splitting plane is determined by evaluating different candidate planes based on the SAH. For each candidate splitting plane, the SAH cost is evaluated which considers a surface area cost and a traversal cost. The splitting plane that minimizes the SAH cost is selected and the current cluster of triangles is divided into two sub-clusters based on the selected splitting plane. Each sub-cluster will represent a child node in the BVH. This process is performed recursively for each child node (sub-cluster) until a termination condition is met (e.g., maximum depth of the BVH, minimum number of triangles per node, etc.).

In an implementation, vertices corresponding to each triangle in each SAH cluster are encoded by the encoding circuitry to generate quantized vertices per-triangle (block 404). In one example, vertices are defined on a signed fixed-point grid to quantize vertices data. For example, for quantization of data pertaining to vertices, vertices data is first defined using a 24-bit signed base position in the grid. In an implementation, a variable-width (e.g., 1-16 bits) unsigned offset for each vertex (relative to the base position) is further generated. Finally, a power-of-2 scale factor, used to map the quantization grid to floating-point coordinates for each triangle vertex, is stored as an “IEEE biased exponent”. The IEEE biased exponent is a component of the floating-point representation used in the “IEEE 754 standard” for representing real numbers in computers. In this standard, a floating-point number is typically represented as a combination of three components: the sign bit, the exponent, and the significand (or mantissa). The biased exponent is a way to represent the exponent with a fixed offset that allows for various comparison and arithmetic operations.

The data resultant from vertex quantization, in one implementation, is stored in a DGF block by the encoding circuitry. In one implementation, each DGF block further stores data pertaining to triangle mesh connectivity, i.e., mesh topology data. According to the implementation, mesh topology data is encoded using triangle strips. For each triangle, two control bits are generated that indicate a position of the triangle relative to two previously identified triangles within the strip. In one implementation, these bits are encoded by the encoding circuitry in a manner that they indicate a position of a triangle being currently processed, e.g., based on positions of previously identified triangles within the strip. For instance, the control bits can indicate whether a new strip needs to be initiated using the current triangle, whether a first edge of a last identified triangle needs to be reused for the current triangle, whether a second edge of a last identified triangle needs to be reused for the current triangle, or whether an opposite edge of a predecessor's predecessor triangle is to be reused for the current triangle.

In one implementation, based on the content of the control bits, an index buffer is created. The buffer is divided into two parts: a first array to store bits identifying whether a given index is a first index for a given vertex (“is-first” bits), and a second array to store bits pertaining to non-first indices to vertices (non-first bits). The is-first bits include one bit per vertex reference, indicating whether it is a first reference to a given vertex. In one implementation, the index buffer is compressed by re-ordering vertices by first use and omitting storage of the first index to every vertex, as identified using the is-first bits. This enables calculating the first index of a given vertex, by simply using a counter, e.g., by counting the number of is-first bits that were encountered before the given vertex. In an example, a single is-first bit per index is used to indicate whether it is the first index to its corresponding vertex. In one implementation, the first three vertex references for a triangle, will always be first vertex references, and accordingly corresponding is-first bits for these references need not be stored. Further, the non-first indices are stored using ‘N’ bits per index, wherein the value of N is predefined. In one implementation, the value of N is stored in the header of a corresponding DGF block.

In an implementation, triangles in the mesh can be further reordered or rotated to maximize quantization of mesh topology data. According to the implementation, triangles within the mesh can be reordered and triangle vertices can be rotated in a manner so as to preserve triangle winding. Preserving triangle winding in a mesh is crucial for maintaining the correct orientation of triangles, which directly affects how the mesh is rendered and shaded in computer graphics. The winding order of triangles (i.e., clockwise or counterclockwise winding) determines whether triangles are facing towards or away from the viewer, impacting visibility and rendering outcomes like shading, lighting, and culling.

In an implementation, and multiple DGF block nodes are combined to “bake” a data node (block 406). As described herein, “node baking” refers to the process of precomputing and storing node data or computations for use during runtime. In one example, each DGF block can store data for up to 64 triangles, whereas each data node can store data pertaining to 256 triangles, 256 vertices, and 64 materials. An example shown in the figures depicts a BLAS node 470 comprising a data node 480, which in turn stores multiple DGF block nodes 482. In an implementation, each data node includes multiple DGF block nodes. Further, data pertaining to each BLAS node corresponding to the acceleration structure can be generated by the encoding circuitry based on a reference to corresponding data nodes storing multiple DGF block nodes. Furthermore, corresponding BLAS can be built at runtime using stored DGF block data, thereby reducing acceleration structure build complexity.

In an implementation, mesh topology, if needed, can be reordered based on a remap table 422. The remap table 422 includes a data structure to translate input values (i.e., originally generated mesh topology data) into corresponding output values (reordered mesh topology data) according to a predefined mapping. In one implementation, the remap table 422 has one entry for each triangle. Each entry stores the index of a given triangle in an input triangle ordering (0 . . . N-1), and further stores, an index of each vertex (herein “input vertex”) that corresponds with each of the triangle's 3 vertices (0,1, or 2). This mapping can be used to reorder the mesh topology while maintaining the original triangle ordering.

The reordering of mesh topology data can be performed using a sideband data buffer using offline pre-processing (block 408). In an implementation, the sideband data includes an array of per-triangle elements (colors, normals, etc.). When reordering the topology, the sideband data also needs to be reordered to match the order in which triangles are connected. For each element in the sideband data, the input index from the corresponding remap table 422 entry is loaded, and a corresponding element from sideband data is mapped to the entry. Further, if the data depends on the order of the vertices in the original triangle, then the input vertex ordering from the remap table 422 is used to re-arrange it accordingly.

Based on the reordering of triangles in the mesh, corresponding index buffer data is also updated to generate reordered buffer data 426. The next step in the process is packaging of the encoded DGF blocks 424 and the reordered buffer data 426 (block 410) to generate packaged geometric data for ray tracing and rasterization operations.

The packaged geometric data undergoes processing (e.g., by a GPU or other processing circuitry) for use during runtime asset streaming (block 412), e.g., for dynamically loading and accessing geometric data into a software application or game during its execution or runtime. In an implementation, during streaming operations, the data nodes 480 can be accessed and processed by one or more application drivers, or hardware systems, as and when specific triangle data is required by an application (block 414).

In one implementation, in order to store primitive data in the DGF blocks, primitives are clustered by the encoding circuitry (e.g., using SAH clustering described above) in a manner such that each DGF block stores data corresponding to primitives that are spatially localized in a given scene. That is, data in each DGF block corresponds to clustered primitives that can be grouped together to represent a single node of an acceleration structure. Since the primitives are clustered before the resulting acceleration structure is generated, build speed can be substantially enhanced, e.g., when an acceleration structure builder uses this data to construct an acceleration structure. In an implementation, geometry data stored in each DGF blocks is forwarded by a graphics application directly to a graphics API for post-processing. For instance, a given graphics API can expose ray tracing capabilities to graphics processors (e.g., GPU 205), such that using the obtained quantized geometry data, faster and more economical BVH builds can be realized. In one implementation, the graphics application performs a lowest possible level of geometry clustering for BVH build to store geometry data into DGF blocks. This can be done at the time data nodes are baked (as described in block 406). In one example, in doing so, the graphic API's BVH build can treat 1-32 triangles in any given DGF block as a single primitive, thereby attaining superior BVH build speeds than traditional techniques, as well as reducing count of internal nodes for the acceleration structure.

In various implementations, encoding primitive data using DGF blocks can remove the need to maintain duplicate copies of the primitive data between the graphics application and graphics driver(s), e.g., for rasterization and ray tracing. In an implementation, using DGF blocks to store data for BVH builds also allow for smaller BVH memory footprint. In another implementation, variable-bit precision for encoding geometry is possible, i.e., the primitive data can be encoded using different bit widths, based on different applications, and stored in different DGF blocks. In one implementation, each individual DGF block can store primitive data encoded using varied bit widths. Using DGF blocks can further reduce graphic application overhead, e.g., when preparing data nodes to be sent to driver(s). Further, for traditional ray tracing systems must be designed with lossless triangle compression to provide expected rendering quality. However, using DGF blocks as described herein allow for lossy compression while maintaining rendering quality as well as developer intent.

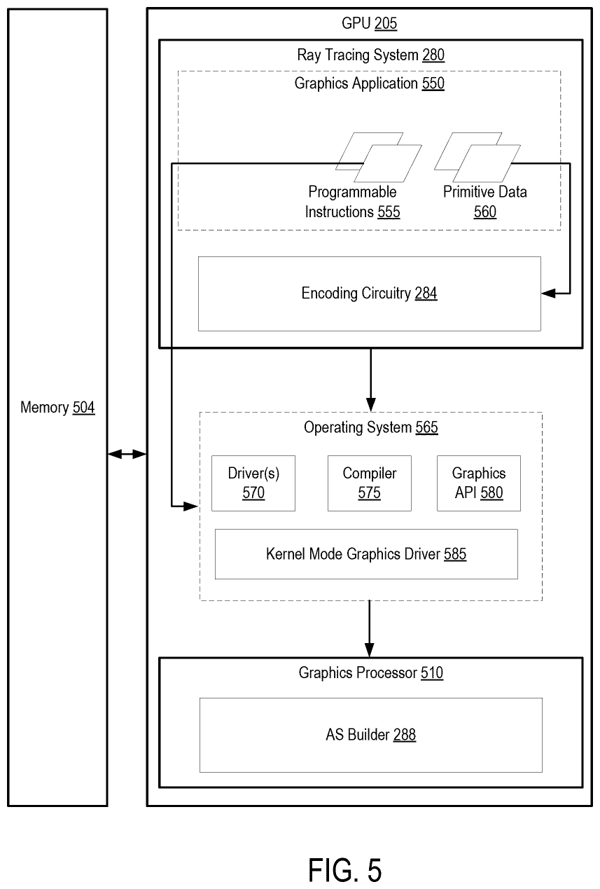

FIG. 5 illustrates a ray tracing system 280 within GPU 205 for constructing an acceleration structure, e.g., a BVH, using quantized primitive data. In one implementation, a graphics application 550 executing on the ray tracing system 280 involve a pipeline of processes that transform three-dimensional (3D) models and scenes into two-dimensional (2D) images through processes like modeling, texturing, animation, scene setup, rendering, and post-processing.

In operation, the graphics application can perform a scene setup, e.g., loading 3D models, setting up camera and lighting effects, and adding level of detail (LOD) for each of the scene elements. At a time in the processing pipeline, when the scene setup is complete, the scene is broken down into individual primitives, along with primitive data corresponding to each primitive. In one example, 3D models can be represented using meshes, that are a collection of vertices, edges, and faces (e.g., triangles and quads). The complex surfaces in the scene are broken down into smaller, simpler primitives, such as subdividing a polygon into triangles. The scene is organized into a hierarchy where each geometrical object can be composed of multiple primitives. Further, vertices, edges, and triangles are defined. Vertices represent the most basic element defining a location in 3D space. Edges connect two vertices to form a line segment. Lastly, triangles connect multiple points to form a flat surface. Primitives other than triangles are also similarly generated.

In one implementation, based on these processes, the graphics application 550 generates programmable instructions 555 for the GPU 205 via driver(s) 570 that interacts with a host system's (not shown) operating system (OS) 565. According to the implementation, the programmable instructions 555 at least include shader instructions written in a high-level shader language like the High Level Shader Language (HLSL) or the OpenGL Shader Language (GLSL). Additionally, the programmable instructions 555 include instructions in a machine language appropriate for execution by general-purpose processor cores (not shown). In some embodiments, the OS 565 can be a Microsoft® Windows® operating system from Microsoft Corporation, a proprietary UNIX-like operating system, or an open-source UNIX-like operating system utilizing a Linux® kernel variant.

This OS 565 can support a graphics API 580, such as the Direct3D API, the OpenGL API, or the Vulkan API. When using the graphics API 580, the OS 565 employs a front-end shader compiler 575 to compile shader instructions written in HLSL into a lower-level shader language. This compilation can be done just-in-time (JIT) or through shader pre-compilation by the application. In some cases, high-level shaders are compiled into low-level shaders during the 3D graphics application 550 compilation. Additionally, shader instructions may be provided in an intermediate form, such as a version of the Standard Portable Intermediate Representation (SPIR) used by the Vulkan API.

In some embodiments, driver 570 can include a user mode graphics driver and a back-end shader compiler that converts shader instructions into a hardware-specific format. When using the graphics API 580, shader instructions written in GLSL are passed to the driver 570 for compilation. The driver 570 further communicates with a kernel mode graphics driver 585. The kernel mode graphics driver 585, in turn, communicates with the graphics processor 510 to dispatch commands and instructions.

As shown, the graphics application 550 further generates primitive data 560, e.g., resulting from a scene setup. In an implementation, the primitive data 560 includes vertices data, edges data, and indices data. In one implementation, the primitive data 560 is processed by encoding circuitry 284. The encoding circuitry encodes the primitive data 560 and stores these data in fixed-size data blocks (i.e., DGF blocks). For instance, for vertex data is encoded using variable-size integer offsets. In one example, floating-point vertex coordinates are pre-quantized into integers and stored as offsets relative to a base point (e.g., the minimum vertex value in a triangle mesh). The encoding circuitry 284 can encode each component of the vertex (e.g., x, y, z) separately using variable-size integers. The encoded data can further include a vector that specifies the direction perpendicular to the surface at the vertex (i.e., “normal vectors” or “normals”). Further, if the object is textured, the data can include texture coordinates that specify how textures are mapped onto the surface.

In one implementation, encoded vertex data and other triangle data is stored as primitive meshes. The primitive mesh data includes a set of vertices, where each vertex is defined by its 3D position and additional attributes like normals, texture coordinates, or colors. The mesh is composed of primitives, where each primitive is defined by indices pointing to the vertex data. In one implementation, mesh connectivity data is encoded by encoding circuitry 284 using a triangle strip, and a compressed index buffer. In any given triangle strip, each triangle shares an edge with the previous triangle in the sequence. This shared edge is formed by two consecutive vertices in the vertex list. In one implementation, by sharing vertices between adjacent triangles, triangle strips require fewer vertex data compared to individual triangles, which reduces memory consumption and improves rendering performance.

In one or more implementations, the compressed index buffer includes a fixed number of control bits per-triangle in the triangle strip (e.g., 2 bits), wherein each control bit indicates the triangle's position relative to previously identified triangles in the strip. In an implementation, the length (or size) of the index buffer is determined based on the contents of the control bits. In one implementation, the index buffer is compressed by re-ordering vertices by first use and omitting storage of the first index to every vertex.

As described earlier, the mesh connectivity data and the compressed index buffer can be stored as DGF blocks. In an implementation, prior to encoding of the primitive data 560 is pre-clustered, e.g., based on a surface area heuristic (SAH). In one implementation, in order to store primitive data in the DGF blocks, primitives are pre-clustered in a manner such that each block stores data corresponding to primitives that are spatially localized in a given scene. That is, data in each DGF block corresponds to primitives that can be grouped together to represent a single node of the acceleration structure to be built. Since the primitives are already clustered before the acceleration structure is generated, the build speed can be substantially enhanced. For example, a predetermined number of DGF blocks (e.g., storing data for a total of 65-128 primitives) can together form a data node that represents a single bottom-level acceleration structure (BLAS) internal node of a BVH. The BLAS node can then be constructed using this data node (e.g., using a node reference created at the time of encoding the DGF blocks). This acceleration structure can then be combined with other nodes to complete construction of the BVH. In one example, each DGF block can store data for up to 64 triangles, whereas each data node (formed using an array of DGF blocks) can store data pertaining to 256 triangles, 256 vertices, and 64 materials. This data can be stored in a memory 504 and processed to complete building of the BVH 304.

In one implementation, the DGF blocks storing encoded primitive data are directly received by the graphics API 580. The graphics API 580 provides necessary functionalities to handle acceleration structure build. For instance, graphics API 580 can expose ray tracing capabilities to graphics processor 510, such that using the obtained quantized geometry data, faster and more economical BVH builds can be realized. In one implementation, since a lowest possible level of geometry clustering for BVH build is performed, to store geometry data into DGF blocks, the graphic API 580 can treat a predefined number of triangles in any given DGF block as a single primitive. This can allow for acceleration structure (AS) builder 288 executing on the graphics processor 510 to attain superior BVH build speeds over traditional techniques, as well as substantially reduce the number of BVH internal nodes allowing for more efficient traversal.

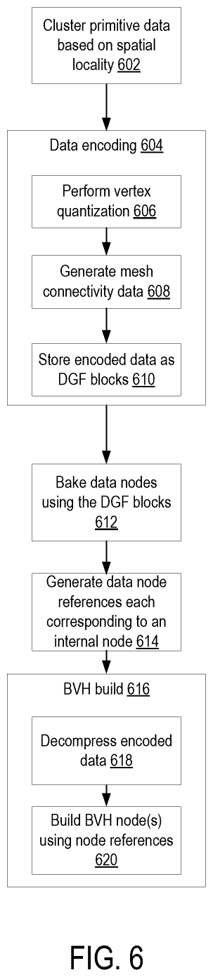

FIG. 6 illustrates a method for encoding primitive data using DGF blocks to be used for constructing acceleration structures. As described in the foregoing, geometrical primitives generated by a graphics application are encoded and the encoded data is stored using data arrays of fixed-size data blocks to be directly consumed by a processing circuitry (e.g., GPU 205) for ray traversal or rasterization.

In an implementation, primitives are first clustered (block 602) in a manner such that each data block stores data corresponding to primitives that are spatially localized in a given scene. That is, data in each data block corresponds to primitives that can be grouped together to represent a single node of the acceleration structure. Since the primitives are clustered before the resulting acceleration structure is construct, build speed can be substantially enhanced. In one implementation, a first circuitry (such as encoding circuitry 284) is configured to perform the clustering.

In one example, a predetermined number of data blocks (e.g., storing data for a total of 65-128 primitives) can together form a data node that represents a single BLAS internal node of a BVH. A data node reference is generated for each data node storing multiple data blocks, e.g., at a point when these data nodes are baked. This reference can be mapped to the BLAS node it represents. A second circuitry (e.g., the ASB 288) can use these data note references to construct BLAS nodes. The second circuitry can further combine the BLAS nodes with other top-level acceleration structures (TLAS) and BLAS nodes to complete construction of the BVH. These and other implementations are described herein.

The clustered data then undergoes data encoding (block 604). In an implementation, vertices corresponding to each triangle in each cluster are encoded by the first circuitry to generate quantized vertices (block 606), e.g., by defining vertices on a signed fixed-point grid. Further, mesh connectivity data is encoded (block 608), e.g., using triangle strips. In an implementation, the first circuitry generates, for each triangle, two control bits that indicate a position of the triangle relative to two previously identified triangles within the strip. In one implementation, these bits are encoded by the first circuitry, such that they indicate a position of a triangle being currently processed, e.g., based on positions of previously identified triangles within the strip. For instance, the control bits can indicate whether a new strip needs to be initiated using the current triangle, whether a first edge of a last identified triangle needs to be reused for the current triangle, whether a second edge of a last identified triangle needs to be reused for the current triangle, or whether an opposite edge of a predecessor's predecessor triangle is to be reused for the current triangle.

The data resultant from encoding vertex data and mesh connectivity data is stored in one or more DGF blocks (block 610) by the first circuitry. In one implementation, multiple DGF block nodes are combined as part of a process to “bake” a data node (block 612). In one example, each DGF block can store data for up to 64 triangles, whereas each data node can store data pertaining to 256 triangles, 256 vertices, and 64 materials. Further, a reference can be generated, e.g., that maps a BLAS node corresponding to a BVH to corresponding data nodes storing multiple DGF block nodes (block 614). That is, BLAS nodes can be built at runtime using references to stored DGF block data, thereby reducing BVH build complexity.

The second circuitry can use the encoded data stored in DGF blocks to build the BVH (block 616). In operation, a graphics API receives the encoded data as an input, which can be decompressed (block 618), e.g., by a third circuitry (e.g., decompression circuitry 286) for further processing. In one example, the decompressed data is used by the second circuitry to build the BVH. As described above, references that map BLAS nodes of the BVH to corresponding DGF block data can be generated. The second circuitry can further use these references to construct the BLAS nodes, as well as combine these BLAS nodes with other BLAS and TLAS nodes to complete construction of the BVH (block 620).

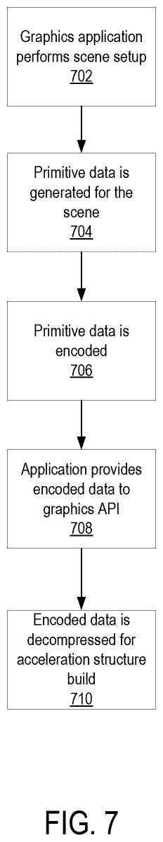

FIG. 7 illustrates a method for constructing an acceleration structure using encoded primitive data. As shown in the figure, a graphics application (e.g., a game application) performs a scene setup (block 702). A graphics application can perform a scene setup by loading 3D models, setting up camera and lighting effects, and adding level of detail (LOD) for each of the scene elements. When the scene setup is complete, an encoding circuitry can break down the scene into individual primitives, along with primitive data corresponding to each primitive (block 704). For example, 3D models can be represented using meshes, that are a collection of vertices, edges, and faces (e.g., triangles and quads). The complex surfaces in the scene are broken down into smaller, simpler primitives, such as subdividing a polygon into triangles. The scene is organized into a hierarchy where each geometrical object can be composed of multiple primitives. Further, vertices, edges, and triangles are defined.

In one implementation, the primitive data is encoded by the encoding circuitry for further processing (block 706). As described in the foregoing, geometrical primitives are encoded and the encoded data is stored using data arrays of fixed-size data blocks to be directly consumed by a processing circuitry for ray traversal or rasterization. In one or more implementations, the encoded data is generated by the encoding circuitry in the form of DGF blocks that include various data buffers to store information pertaining to vertex indices, geometry identifiers, mesh connectivity, and opacity data pertaining to each primitive in the mesh. In one implementation, the DGF block is a fixed-size data block, e.g., consisting of an array of data blocks of 128 bytes that encode triangle data. In this example, each data block stores a maximum of 64 triangles and 64 vertices. In one implementation, in order to store encoded primitive data in the data blocks, primitives are pre-clustered by the encoding circuitry in a manner such that each data block stores data corresponding to primitives that are spatially localized in a given scene. That is, data in each data block corresponds to primitives that can be grouped together to represent a single node of an acceleration structure.

The graphics application provides encoded primitive data to a graphics API (block 708). The encoded data stored using the fixed-size data blocks (DGF blocks) can be efficiently decompressed by a decompression circuitry and used for construction of the acceleration structure (block 710), e.g., by an acceleration structure builder (e.g., ASB 288). The API receiving encoded primitive data stored using DGF blocks has the advantages of lossless compression, while remaining true to an application developer's intent for the data. Implementations described herein allow the developer to provide pre-quantized primitive data of any bit width, and the graphics API can preserve the data's intent precisely. Further, providing quantized primitive data in DGF blocks can help avoid any rewriting or repacking of the application data.

Further, the graphics API can expose ray tracing capabilities to a graphics processors to construct faster and more economical BVH using the encoded data directly from the DGF blocks. In one implementation, the graphics application performs a lowest possible level of geometry clustering for BVH build to store geometry data into DGF blocks. This can be done at the time data nodes comprising the DGF blocks are baked (as described in FIG. 4). In one example, in doing so, the graphic API's BVH build can treat 1-32 triangles in any given DGF block as a single primitive, thereby attaining superior BVH build speeds than traditional techniques, as well as reducing count of internal nodes for the acceleration structure.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. An apparatus comprising:
first circuitry configured to store quantized primitive data as one or more fixed-size data blocks, wherein quantized primitive data stored in each data block corresponds to primitives that are grouped together to represent at least one node of an acceleration data structure; and
second circuitry configured to:
receive the one or more fixed-size data blocks as input; and
construct the acceleration data structure based at least in part on quantized primitive data stored in each of the one or more fixed-size data blocks.

2. The apparatus as claimed in claim 1, wherein the at least one node is a bottom-level acceleration structure (BLAS) internal node of the acceleration data structure.

3. The apparatus as claimed in claim 2, wherein a predetermined number of data blocks of the one or more fixed-size data blocks together form a data node, wherein the data node represents the BLAS internal node of the acceleration data structure.

4. The apparatus as claimed in claim 1, wherein a first data block stores data encoded using a first bit width and a second data block stores data encoded using a second bit width different than the first bit width.

5. The apparatus as claimed in claim 1, wherein to quantize the primitive data, the first circuitry is configured to:
generate control values, wherein each control value is indicative of a position of a geometrical primitive relative to one or more previously identified geometrical primitives;
generate a compressed index buffer comprising a plurality of index bits, each index bit indicative of one of a first reference and a non-first reference to a given vertex of the geometrical primitive; and
store, using the one or more fixed-size data blocks, data corresponding to the control values and the compressed index buffer as quantized primitive data.

6. The apparatus as claimed in claim 1, wherein the second circuitry is configured to receive the one or more fixed-size data blocks as input, through a graphics application programming interface (API).

7. The apparatus as claimed in claim 6, wherein primitives in each cluster comprise primitives that together represent a single node of the acceleration data structure.

8. A method comprising:
quantizing, by a first circuitry, primitive data corresponding to a set of primitives;
storing, by the first circuitry, quantized primitive data as one or more fixed-size data blocks, wherein quantized primitive data stored in each data block corresponds to primitives that are grouped together to represent at least one node of an acceleration data structure;
receiving, by a second circuitry, the one or more fixed-size data blocks as input; and
constructing, by the second circuitry, the acceleration data structure based at least in part on quantized primitive data stored in each of the one or more fixed-size data blocks.

9. The method as claimed in claim 8, further comprising receiving, by the second circuitry, the one or more fixed-size data blocks as the input, through a graphics application programming interface (API).

10. The method as claimed in claim 9, wherein a predetermined number of data blocks of the one or more fixed-size data blocks together form a data node, and wherein the data node represents at least one bottom-level acceleration structure (BLAS) internal node of the acceleration data structure.

11. The method as claimed in claim 8, wherein a first data block stores data encoded using a first bit width and a second data block stores data encoded using a second bit width different than the first bit width.

12. The method as claimed in claim 8, wherein to quantize the primitive data, the method comprising:
generating, by the first circuitry, control values, wherein each control value is indicative of a position of a geometrical primitive relative to one or more previously identified geometrical primitives;
generating, by the first circuitry, a compressed index buffer comprising a plurality of index bits, each index bit indicative of one of a first reference and a non-first reference to a given vertex of the geometrical primitive; and
storing, by the first circuitry using the one or more fixed-size data blocks, data corresponding to the control values and the compressed index buffer as quantized primitive data.

13. The method as claimed in claim 8, wherein the set of primitives are clustered in one or more clusters, prior to quantization, based at least in part on a surface area heuristic, such that each primitive in a cluster shares a spatial locality corresponding to a scene with other primitives within the cluster.

14. The method as claimed in claim 13, wherein primitives in each cluster comprise primitives that together represent a single node of the acceleration data structure.

15. A processor comprising:
ray tracing circuitry configured to:
store quantized primitive data as one or more fixed-size data blocks; and
construct an acceleration data structure based at least in part on quantized primitive data stored in each of the one or more fixed-size data blocks; and
a plurality of compute circuits configured to render image data using the acceleration data structure.

16. The processor as claimed in claim 15, wherein at least one internal node of the acceleration data structure is a bottom-level acceleration structure (BLAS) internal node.

17. The processor as claimed in claim 16, wherein a predetermined number of data blocks of the one or more fixed-size data blocks together form a data node that represents the BLAS internal node of the acceleration data structure.

18. The processor as claimed in claim 15, wherein a first data block stores data encoded using a first bit width and a second data block stores data encoded using a second bit width different than the first bit width.

19. The processor as claimed in claim 18, wherein the first data block comprises data corresponding to multiple dense geometry format data blocks.

20. The processor as claimed in claim 15, wherein the plurality of compute circuits are configured to perform ray intersection tests using data stored in the acceleration data structure.
